(19) United States
(12) Patent Application Publication
(10) Pub. No.: US 2003/0066077 A1
(43) Pub. Date: Apr. 3, 2003

(54) Method and system for viewing multiple programs in the same time slot

(75) Inventors: Srinivas Gutta, Yorktown Heights, NY (US); Lalitha Agnihotri, Fishkill, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/970,248

(22) Filed: Oct. 3, 2001

(51) Int. Cl. H04N 7/025; H04N 7/10; G06F 3/00; H04N 5/445; G06F 13/00

(52) U.S. Cl. 725/34; 725/35; 725/46

(57) ABSTRACT

A multiple viewing program recommendation system employing a commercial detection module and a multiple viewing module is disclosed. In response to a generation of viewing recommendations of two or more program during the same time slot, the multiple viewing module controls a display of a recommended program having the highest viewing priority on a television screen while the recommended program is being aired on one of the television channels until the commercial detection module detects a commercial being aired on the television channel. In response to the detection of the commercial by the commercial detection module (37), the multiple viewing module controls a display of an additional recommended program having the next highest viewing priority on the television screen while the additional recommended program is being aired on another one of the television channels.

### BACKGROUND OF THE INVENTION

1. Field of the Invention

The present invention relates to systems that employ an electronic program guide to assist a media user in managing a large number of media-content choices (e.g., television programming, chatrooms, on-demand video media files, audio, etc.). The present invention more specifically relates to systems having the “intelligence” to suggest choices to a user and to take actions based on the suggestions (e.g., record a program on behalf of the user).

2. Description of the Related Art

As the number of channels available to television viewers has increased, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, the ability to effectively identify desirable television programs using such printed guides has become impractical.

More recently, television program guides have become available in an electronic format, often referred to as electronic program guides (EPGs). Like printed television program guides, EPGs contain grids listing the available television programs by time, date, channel and title. An EPG, however, allows television viewers to sort or search the available television programs in accordance with personalized preferences. In addition, EPGs allow for on-screen presentation of the available television programs.

While EPGs allow viewers to identify several desirable programs more efficiently than conventional printed guides, they suffer from a number of limitations, which if overcome, could further enhance the ability of viewers to identify desirable programs. For example, many viewers have a particular preference towards, or bias against, certain categories of programming, such as action-based programs, or sports programming. Thus, the viewer preferences can be applied to the EPG to obtain a set of recommended programs that may be of interest to a particular viewer.

The ultimate goal in the design of a television program recommendation program is to achieve the best possible classification of programs. This objective led to the development of television recommendation programs for recommending a program having the highest ranking for each time slot. However, in some cases, two or more programs may receive the highest ranking for a particular time slot. Prior to the present invention, the viewer either had to choose to view one program during the time slot while taping or missing the other recommended program(s), or manually switch between two or more of the recommended program(s) during the time slot.

### SUMMARY OF THE INVENTION

The present invention relates to a multiple viewing recommendation program that overcomes the disadvantages associated with the prior art. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a method for selectively displaying two or more recommended programs on a television screen during a time slot. First, a computer is operated to control a display of a first recommended program having a first highest viewing priority on the television screen during the time slot while it is being aired on a first channel during the time slot. Second, the computer is operated to control a display of a second recommended program having a second highest viewing priority on the television screen during the time slot while the second recommended program is being aired on a second channel during the time slot and a commercial is being aired on the first channel during the time slot.

A second form of the present invention is a computer system for selectively displaying two or more recommended programs on a television screen during a time slot. The computer system comprises a commercial detection module and a multiple viewing module. The commercial detection module is operable to detect a commercial being aired on a first channel during the time slot. The multiple viewing module is operable to control a display of a first recommended program having a first highest viewing priority on the television screen while it is being aired on the first channel during the time slot. The multiple viewing module is further operable to control a display of a second recommended program having a second highest viewing priority on the television screen while the second recommended program is being aired on the second channel during the time slot in response to a detection of the commercial being aired on the first channel during the time slot.

A third form of the present invention is a computer program product in a computer readable medium for selectively displaying two or more recommended programs on a television screen during a time slot. The computer program product includes computer readable code for controlling a display of a first recommended program having the first highest viewing priority on the television screen during the time slot while it is being aired on a first channel during the time slot, and computer readable code for controlling a display of a second program having a second highest viewing priority on the television screen while the second recommended program is being aired on a second channel during the time slot and a commercial is being aired on the first channel during the time slot.

The foregoing forms and other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a schematic diagram of one embodiment in accordance with the present invention of an automated recommendation system;

FIG. 2 illustrates a block diagram of one embodiment in accordance with the present invention of a computer of the FIG. 1 system;

FIG. 3 illustrates a flow chart of a multiple viewing program recommendation routine in accordance with the present invention;

FIG. 4 illustrates a flow chart of a first embodiment of a display control routine in accordance with the present invention;

FIG. 5A illustrates a first exemplary display of two programs in accordance with the FIG. 4 routine;

FIG. 5B illustrates a second exemplary display of two programs in accordance with the FIG. 4 routine;

FIG. 5C illustrates a third exemplary display of two programs in accordance with the FIG. 4 routine; and

FIG. 6 illustrates a flow chart of a second embodiment of a display control routine in accordance with the present invention.

### DETAILED DESCRIPTION OF THE PRESENTLY PREFERRED EMBODIMENTS

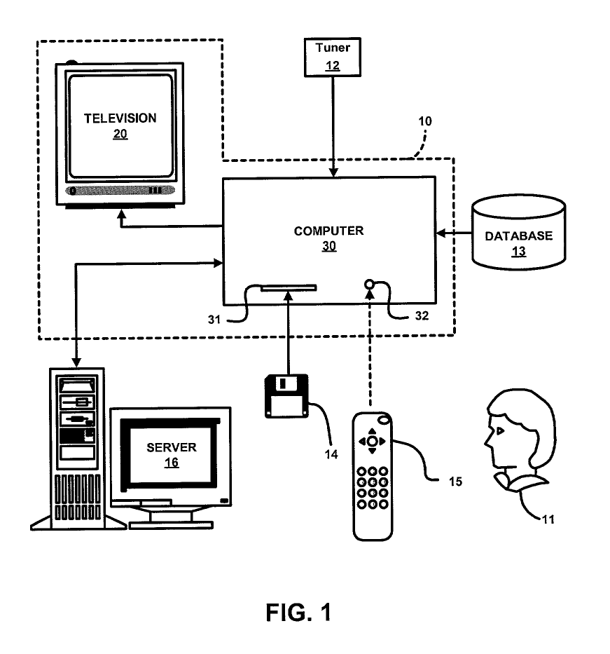

FIG. 1 illustrates an automated program recommendation system 10 for a user 11. System 10 comprises a display device in the form of a conventional television 20 as well a computer 30. Computer 30 can be housed within television 20 or set apart from television 20 as shown.

In the illustrated embodiment, computer 30 is equipped to receive program schedule data (e.g., an electronic program guide) from a server 16. Computer 30 can optionally receive feedback profile data, implicit profile data, and/or explicit profile data of other system 10 users from server 16. Computer 30 is further equipped to receive a video signal including program schedule data from a tuner 12 (e.g., a cable tuner or a satellite tuner). Computer 30 is also equipped with an infrared port 32 to allow user 11 to select a program to be viewed via a remote control 15. For example, user 11 can utilize remote control 15 to highlight a desired selection from an electronic program guide displayed on television 20. Computer 30 can have access to a database 13 from which computer 30 can receive updated program schedule data. The access can be accomplished by a telephone line connectable to an Internet service provider or some other suitable data connection. Computer 30 is further equipped with a disk drive 31 to upload program schedule data, profile data of user 11, and profile data of other system 10 users via a removable media such as a disk 14.

Computer 30 may be configured in any form for accepting structured inputs, processing the inputs in accordance with prescribed rules, and outputting the processing results to thereby control the display of television 20 as would occur to those having ordinary skill in the art. Computer 30 may therefore be comprised of digital circuitry, analog circuitry, or both. Also, computer 30 may therefore be programmable, a dedicated state machine, or a hybrid combination of programmable and dedicated hardware.

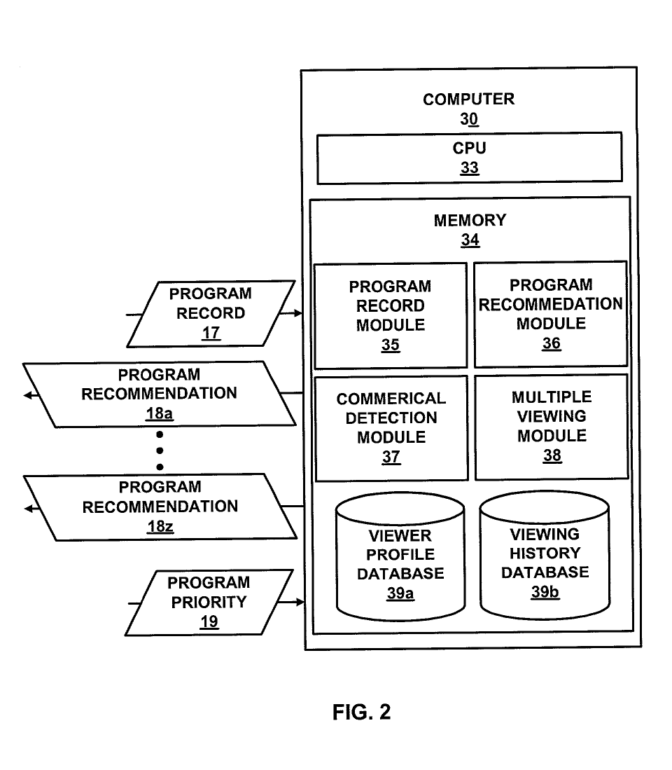

FIG. 2 illustrates one embodiment of computer 30. In the illustrated embodiment, computer 30 includes a central processing unit (CPU) 33 operatively coupled to a solid-state memory 34. CPU 33 can be from the Intel family of microprocessors, the Motorola family of microprocessors, or any other type of commercially available microprocessor. Memory 34 is a computer readable medium (e.g., a read-only memory, an erasable read-only memory, a random access memory, a compact disk, a floppy disk, a hard disk drive, and other known forms) that is electrically, magnetically, optically or chemically altered to contain computer readable code corresponding to a program record module 35, a program recommendation module 36, a commercial detection module 37, and a multiple viewing module 38. Additionally, memory 34 stores a viewing profile database 39a of user 11 (FIG. 1), and a viewer history database 39b of user 11 (FIG. 1). To execute the computer readable code within memory 34, computer 30 can additionally include any control clocks, interfaces, signal conditioners, filters, Analog-to-Digital (A/D) converters, Digital-to-Analog (D/A) converters, communication ports, or other types of operators as would occur to those having ordinary skill in the art.

In alternative embodiments of computer 30, program record module 35, program recommendation module 36 commercial detection module 37, and/or multiple viewing module 38 can be partially or fully implemented with digital circuitry, analog circuitry, or both (e.g., an application specific integrated circuit).

In response to a reception of multiple program records 17 during a time slot from a program schedule data such as an EPG, CPU 33 controls an execution of program record module 35 for conventionally processing program record 17 whereby a routine 40 of the present invention can be implemented.

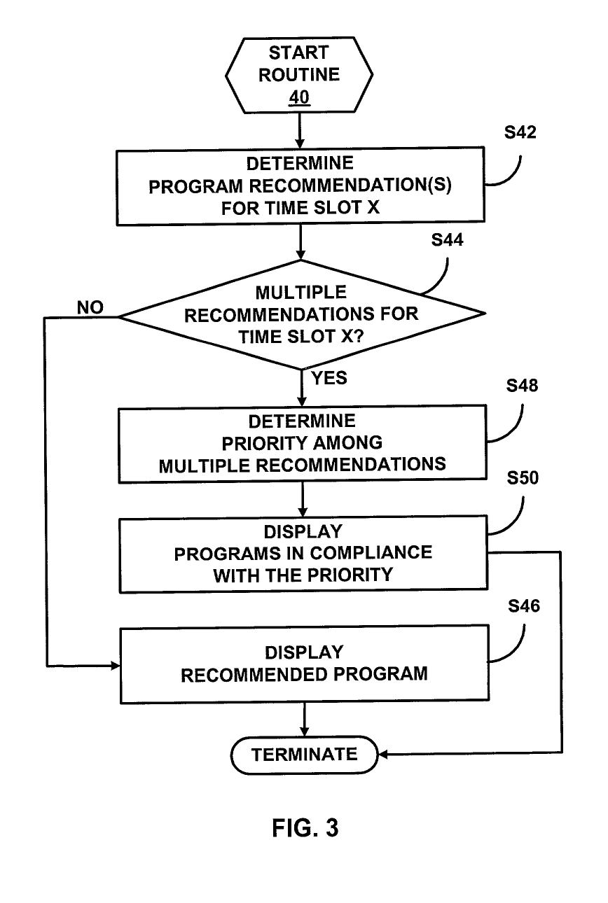

FIG. 3 illustrates routine 40. In the illustrated embodiment, during a stage S42 of routine 40, CPU 33 controls an execution of program recommendation module 36 to determine recommendations of one or more programs indicated by program records 17. Program recommendation module 36 is one of many prior art programs for providing a recommendation based upon the well-established theory of concept learning. In one embodiment, program recommendation module 36 is a decision tree classifier disclosed in U.S. patent application Ser. No. 09/466,406, filed Dec. 17, 1999, and entitled “METHOD AND APPARATUS FOR RECOMMENDING TELEVISION PROGRAMMING USING DECISION TREES”, the entirety of which is hereby incorporated herein by reference and assigned to the assignee of the present application. In a second embodiment, program recommendation module 36 is a Bayesian classifier disclosed in U.S. patent application Ser. No. 09/498,271, filed Feb. 4, 2000, and entitled “BAYESIAN TV PROGRAM RECOMMENDER”, the entirety of which is hereby incorporated herein by reference and assigned to the assignee of the present application. In a third environment, program recommendation module 36 is a nearest neighbor classifier disclosed in U.S. patent application Ser. No. 09/975,594, filed Jun. 6, 2001, and entitled “NEAREST NEIGHBOR RECOMMENDATION METHOD AND SYSTEM”, the entirety of which is hereby incorporated herein by reference and is assigned to the assignee of the present invention. During a stage S44 of routine 40, CPU 33 determines if program recommendation module 36 generated two or more recommendations during stage S42. When CPU 33 determines that program recommendation module 36 provided one recommendation during stage S42, CPU 33 executes multiple viewing module 38 during a stage S46 of routine 40 to control a display of the program corresponding to the recommendation on a screen of television 20 (FIG. 1) during the time slot. When CPU 33 determines that program recommendation module 36 provided two or more recommendations during stage S42 (e.g., recommendations having the same score, or within a specified range of scores), CPU 33 executes multiple viewing module 38 during a stage S48 of routine 40 to determine a viewing priority among the multiple recommendations. In one embodiment, multiple viewing module 38 controls a display of program recommendations 18a-18z on the screen of television 20 whereby user 11 can provide a program priority input 19 ranking each program recommendation 18a-18z. In another embodiment, multiple viewing module 38 ranks the program recommendation 18a-18z based upon its scoring system.

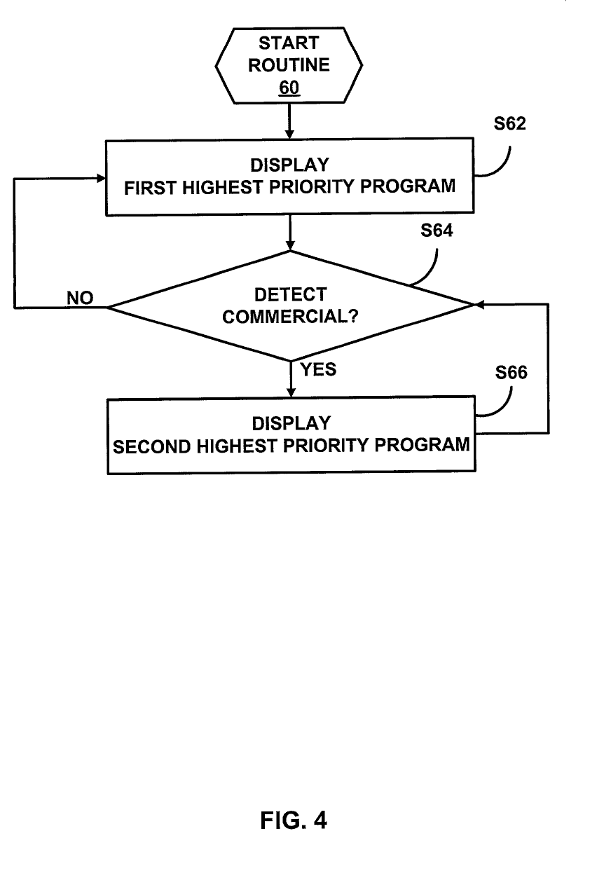

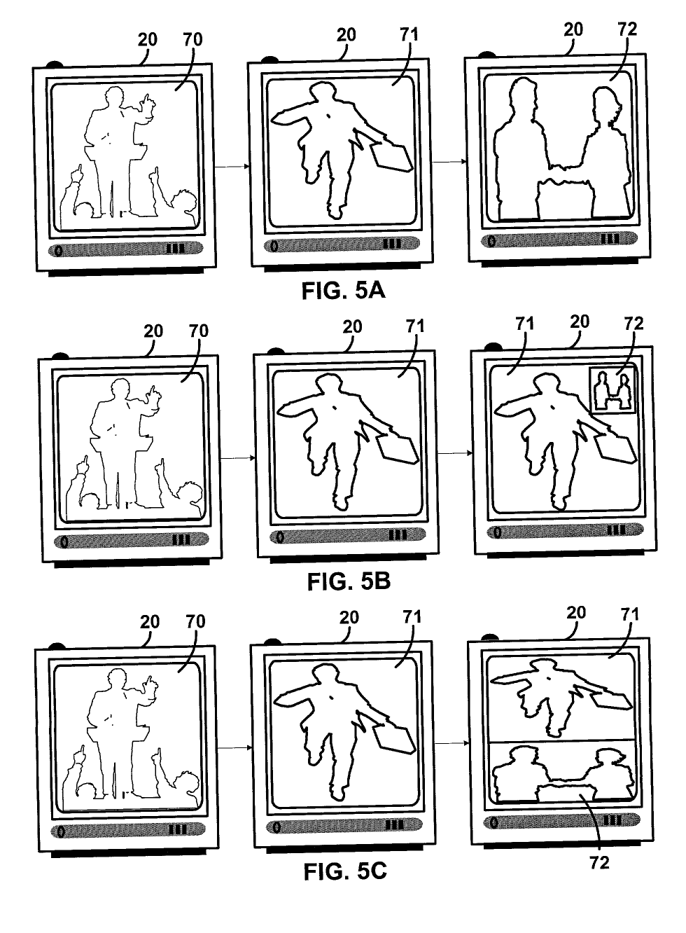

During a stage S50 of routine 40, CPU 33 executes execution of multiple viewing module 38 to selectively control one or more programs corresponding to program recommendation 18a-18z. In one embodiment of stage S50 of routine 40, a subroutine 60 is implemented during stage S50. FIG. 4 illustrates subroutine 60. During a stage S62 of routine 60, CPU 33 executes multiple viewing module 38 to control a display of a program recommendation having the first highest viewing priority on the screen of television 20. For example, CPU 33 executes multiple viewing module 38 to control a display 70 of a program recommendation of a presidential press conference being aired on CNN as illustrated in FIGS. 5A-5C when the presidential press conference has the first highest viewing priority.

During a stage S64 of routine 60, CPU 33 executes commercial detection module 37 to detect when a commercial is being aired on the same channel as the program recommendation having the first highest viewing priority. In one embodiment, commercial detection module 37 is designed in accordance with the principles of U.S. Pat. No. 6,100,941, entitled “APPARATUS AND METHOD FOR LOCATING A COMMERCIAL DISPOSED WITHIN A VIDEO DATA STREAM”, the entirety hereby incorporated by reference. In another embodiment, commercial detection module 37 is designed in accordance with U.S. patent application Ser. No. 09/875,594, entitled “METHOD OF USING TRANSCRIPT INFORMATION TO IDENTIFY AND LEARN COMMERCIAL PORTIONS OF A PROGRAM” and filed Jun. 6, 2001, hereby incorporated by reference.

CPU 33 continually implements stages S62 and S64 when CPU 33 determines commercial detection module 37 is not detecting a commercial being aired on the same channel as the program recommendation having the first highest viewing priority during stage S64. CPU implements a stage S66 of routine 60 when CPU 33 determines commercial detection module 37 is detecting a commercial being aired on the same channel as the program recommendation having the first highest viewing priority during stage S64. During stage S66, CPU 33 executes multiple viewing module 38 to control a display of a program recommendation having the second highest viewing priority on the screen of television 20. For example, CPU 33 executes multiple viewing module 38 to control a display 72 of a program recommendation of a congressional debate conference being aired on MSN when commercial detection module 37 detects a display of a rent-a-car commercial being aired on CNN during the time slot. In one embodiment, multiple viewing module 38 controls display 72 as a full picture on the entire screen of television 20 as shown in FIG. 5a. In a second embodiment, multiple viewing module 38 controls display 72 as a picture-in-a-picture of display 71 on the screen of television 20 as shown in FIG. 5b. In a third embodiment, multiple viewing module 38 controls display 71 and display 72 on a split screen of television 20 as shown in FIG. 5c.

In a second embodiment of stage S50 of routine 40, a subroutine 80 is implemented during stage S50. FIG. 5 illustrates subroutine 60. During a stage S82 of routine 80, CPU 33 executes multiple viewing module 38 to control a display of a program recommendation having the first highest viewing priority on the screen of television 20. During a stage S84 of routine 80, CPU 33 executes commercial detection module 37 to detect when a commercial is being aired on the same channel as the program recommendation having the first highest viewing priority. CPU 33 continually implements stages S82 and S84 when CPU 33 determines commercial detection module 37 is not detecting a commercial being aired on the same channel as the program recommendation having the first highest viewing priority during stage S84.

CPU implements a stage S86 of routine 80 when CPU 33 determines commercial detection module 37 is detecting a commercial being aired on the same channel as the program recommendation having the fist highest viewing priority during stage S84. During a stage S86 of routine 80, CPU 33 executes commercial detection module 37 to detect when a commercial is being aired on the same channel as the program recommendation having the second highest viewing priority.

CPU 33 proceeds to a stage S88 when CPU 33 determines commercial detection module 37 is not detecting a commercial being aired on the same channel as the program recommendation having the second highest viewing priority during stage S86. During stage S88, CPU 33 executes multiple viewing module 38 to control a display of the program recommendation having the second highest viewing priority on the screen of television 20 similarly to the illustrations of FIGS. 5A-5C.

CPU 33 proceeds to a stage S90 when CPU 33 determines commercial detection module 37 is detecting a commercial being aired on the same channel as the program recommendation having the second highest viewing priority during stage S86. During stage S90, CPU 33 executes multiple viewing module 38 to control a display of the program recommendation having the third highest viewing priority on the screen of television 20 similarly to the illustrations of FIGS. 5A-5C.

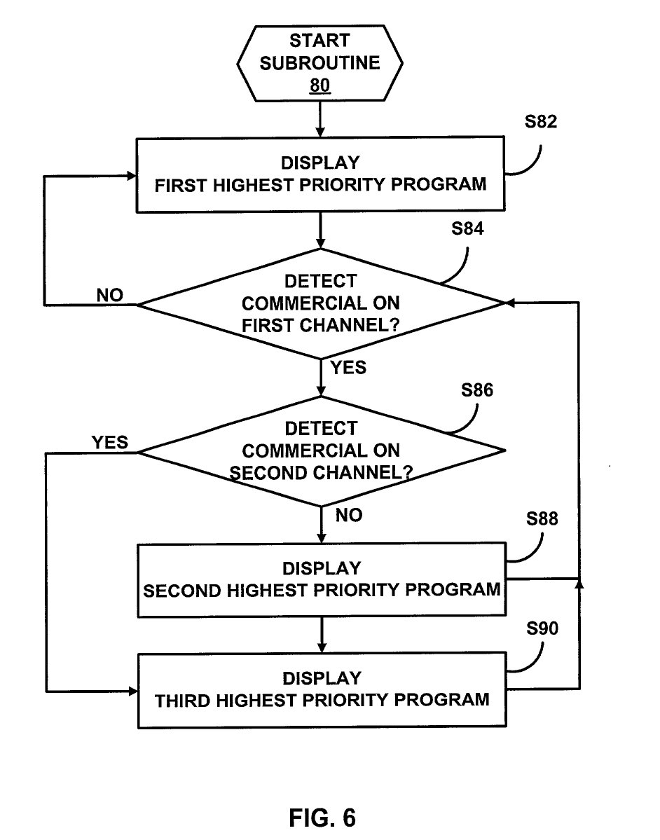

From the description of subroutines 60 (FIG. 4) and 80 (FIG. 6) herein, those having ordinary skill in the art will appreciate the subroutines of the present invention necessary to implement a same slot viewing of four or more recommended programs.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. A method for selectively displaying two or more recommended programs on a television screen during a time slot, said method comprising:
operating a computer to control a display of a first recommended program having the first highest viewing priority on the television screen while it is being aired on a first channel during the time slot; and
operating the computer to control a display of a second recommended program having a second highest viewing priority on the television screen while the second recommended program is being aired on a second channel during the time slot and a first commercial is being aired on the first channel during the time slot.

2. The method of claim 1, further comprising:
operating the computer to control a display of a third recommended program having a third highest viewing priority on the television screen while the first commercial is being aired on the first channel during the time slot and a second commercial is being aired on the second channel during the time slot.

3. The method of claim 1, further comprising:
operating the computer to control a concurrent display of the first commercial and the second recommended program channel on the television screen while the first commercial is being aired on the first channel during the time slot.

4. A computer system for selectively displaying two or more recommended programs on a television screen during a time slot, said computer system comprising:
a commercial detection module operable to detect a first commercial being aired on a first channel during the time slot; and
a multiple viewing module operable to control a display a first recommended program having a first highest viewing priority on the television screen while it is being aired on the first channel during the time slot, said multiple viewing module further operable to control a display of a second recommended program having a second highest viewing priority on the television screen while the second recommended program is being aired on a second channel during the time slot in response to a detection by said commercial detection module of the first commercial being aired on the first channel.

5. The computer system of claim 4, wherein:
said commercial detection module is further operable to detect a second commercial being aired on a second channel during the time slot; and
said multiple viewing module is further operable to control a display of a third recommended program having a third highest viewing priority on the television screen while the third recommended program is being aired on a third channel during the time slot in response to a detection by said commercial detection module of the first commercial being aired on the first channel during the time slot and the second commercial being aired on the second channel during the time slot.

6. The computer system of claim 4, wherein said multiple viewing module is further operable to control a concurrent display of the first commercial and the second recommended program on the television screen while the second program is being aired on the second channel in response to a detection by said commercial detection module of the first commercial being aired on the first channel during the time slot.

7. A computer system for selectively displaying two or more recommended programs on a television screen during a time slot, said computer system comprising:
means for controlling a display of a first recommended program having the first highest viewing priority on the television screen while it is being aired on a first channel during the time slot; and
means for controlling a display of a second recommended program having a second highest viewing priority on the television screen while the second recommended program is being aired on a second channel during the time slot and a first commercial is being aired on the first channel during the time slot.

8. The computer system of claim 7, further comprising:
means for controlling a display of a third recommended program having a third highest viewing priority on the television screen while the first commercial is being aired on the first channel during the time slot and a second commercial is being aired on the second channel during the time slot.

9. The computer system of claim 7, further comprising:
means for controlling a concurrent display of the first commercial and the second recommended program channel on the television screen while the first commercial is being aired on the first channel during the time slot.

10. A computer program product in a computer readable medium for selectively displaying two or more recommended programs on a television screen during a time slot, said computer program product comprising:
computer readable code to control a display of a first recommended program having the first highest viewing priority on the television screen while it is being aired on a first channel during the time slot; and
computer readable code to control a display of a second recommended program having a second highest viewing priority on the television screen while the second recommended program is being aired on a second channel during the time slot and a first commercial is being aired on the first channel during the time slot.

11. The computer program product of claim 10, further comprising:
computer readable code to control a display of a third recommended program having a third highest viewing priority on the television screen while the first commercial is being aired on the first channel during the time slot and a second commercial is being aired on the second channel during the time slot.

12. The computer program product of claim 10, further comprising:
computer readable code to control a concurrent display of the first commercial and the second recommended program channel on the television screen while the first commercial is being aired on the first channel during the time slot.
